(19) United States
(12) Patent Application Publication
(10) Pub. No.: US 2014/0254922 A1
(43) Pub. Date: Sep. 11, 2014

(54) Salient Object Detection in Images via Saliency

(71) Applicant: MICROSOFT CORPORATION, Redmond, WA (US)

(72) Inventors: Jingdong Wang, Beijing (CN); Shipeng Li, Palo Alto, CA (US); Peng Wang, Beijing (CN)

(73) Assignee: MICROSOFT CORPORATION, Redmond, WA (US)

(21) Appl. No.: 13/794,427

(22) Filed: Mar. 11, 2013

(51) Int. Cl. G06K 9/46

(52) U.S. Cl. CPC G06K 9/4671
USPC 382/159

(57) ABSTRACT

An input image, which may include a salient object, is received by a salient object detection and localization system. The system may be trained to detect whether the input image includes a salient object. If the system fails to detect a salient object in the input image, the system may provide the sender of the input with a null result or an indication that the input image does not contain a salient object. If the system detects a salient object in the input image, the system may localize the salient object within the input image. The system may generate an output image based at least in part on the localization of the salient object. The system may provide the sender of the input image with information pertaining to the detected salient object.

### CROSS REFERENCE TO RELATED APPLICATIONS

This disclosure is related to U.S. patent application Ser. No. 13/403,747, filed Feb. 23, 2012, entitled “SALIENT OBJECT SEGMENTATION,” which is incorporated herein by reference in its entirety.

### BACKGROUND

Individuals will recognize an object of interest located in an image, which may be referred to as a main focus of attention for a typical viewer (or a “salient object”). A salient object may be defined as an object being prominent or noticeable. For instance, individuals may detect a salient object in visual images, such as in a photograph, a picture collage, a video, or the like.

Recently, computational models have been created to detect a salient object in an image. These computational models may rely on various methods using computer systems to detect a salient object within an image. One of the computational models computes a saliency value for each pixel based on color and orientation information using “center-surround” operations, akin to visual receptive fields. Another computational model relies on a conditional random fields (CRF) framework to separate a salient object from a background of an image. In yet another example, another computational model defines saliency with respect to all of the regions in the image.

A technique, known as Sliding window, may be utilized to detect salient objects. A sliding window scheme combines local cues for detection. Given a window on the image, the sliding window scheme evaluates the probability that this window contains an object. The sliding window scheme evaluates the entire image or a selected part (or parts) of an image.

A technique for generating bounding boxes may be based on an objectness measure. The technique combines different image objectness cues, such as multi-scale saliency, edge density, color contrast and superpixel straddle, into one Bayesian framework, and a model is trained based on Visual Object Classes (VOC) images. It is difficult to measure a global best bounding box utilizing this technique.

Another technique utilizes a limited number of bounding boxes that have high potential to contain objects for later selection. Similar with objectness, the technique utilizes robust image cues and uses Structured Output Support Vector Machine (SVM) for training in which a cascade scheme is used for acceleration.

Some techniques compute a window saliency based on superpixels. All of the superpixels outside of a window are used to compose the superpixel inside window. Thus, global image context is combined to achieve higher precision than the “Objectness.”

Another technique includes a segmentation-based method. Segmenting refers to a process of partitioning the image into multiple segments, commonly referred to as superpixels, also known as a set of pixels. After segmentation, a bounding box with its edge tangent to an object boundary is proposed. K-nearest neighbor (KNN) may be utilized to retrieve similar images and model the saliency part and background part based on the retrievals in order to obtain the bounding boxes. The salient bounding box is obtained by graph cuts optimization.

Another technique finds the segmentation by using tools, such a Grabcut, iteratively based on proposed saliency maps that are computed by Histogram Contrast or Region Contrast. The segmentation is then refined step by step until convergence.

Another technique generates salient segmentation by integrating Auto-context into saliency cut to combine context information. The technique trains a classifier on pixels at each iteration, which slows down the progress.

Another technique utilizes CRF to incorporate saliency cues from different aspects on the image and outputs a dominant salient object bounding box. But for the reason that the ground truth is weakly labeled as bounding box, the combination parameter is not well supervised.

The above techniques may not efficiently, or at all, detect and localize salient objects for low resolution images such as web images, thumbnails. For the purposes of this disclosure, low resolution images contain around 100 pixels by 100 pixels, which are enough for a human to recognize salient objects, but may be insufficient for segmentation by an image processing system.

### SUMMARY

This disclosure describes detecting and localizing a salient object in an image. In one aspect, a process receives an input image that includes a salient object. The process is trained to detect salient objects in the input image. The process may fragment the input image and generate saliency map(s) and determine whether the input image includes a salient object by utilizing a trained detection model. If the process does not detect a salient object in the input image, the process may discard the input image without attempting to localize a salient object. If the process does detect a salient object in the input image, the process may localize the salient object utilizing a trained localizer. Further, the process may localize the salient object without segmenting. The process may generate an output image with a salient object bounding box circumscribing the detected salient object. The output image may be cropped to the approximate size of the salient image bounding box.

The process may search for images similar in appearance and shape to the salient object in the input image.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1 illustrates an architecture to support an example environment to detect and localize a salient object in an input image.

FIG. 2 is a flowchart to illustrate an example process of machine learning of salient object detection and localization.

FIG. 3 is a flowchart to illustrate another example process of machine learning of salient object detection and localization.

FIG. 4 is a flowchart to illustrate an example process to detect and localize a salient object in an input image.

FIG. 5 is a block diagram to illustrate an example server usable with the environment of FIG. 1.

### DETAILED DESCRIPTION

### Overview

This disclosure describes detecting, in an input image, a salient object located therein and localizing the detected salient object by performing a series of processes on the input image. The disclosure further describes using the localized salient object in various applications, such as image searches, image diagnoses/analyses, image verifications, and the like.

For example, envision that an individual takes a photograph of vehicle “A” parked along a street, in which vehicle “A” is centered in the photograph along with other vehicles parked parallel on the street. The individual, desiring more information about vehicle “A,” then submits the photograph as an input image to a search engine. The search engine relies on a process described below to detect vehicle “A” as the salient object and to localize vehicle “A” in the image. The process performs searches (on the World Wide Web, databases, directories, servers, etc.) based at least in part on the localized salient object for the purpose of detecting search results that are based on this image of vehicle “A.” The process accordingly returns search results that are similar in appearance and shape to the localized salient object. As such, the individual is able to learn information associated with vehicle “A” in response to taking the picture of this vehicle and providing this image to a search engine.

In yet other examples, the localized salient object may be used in a variety of other applications such as medical analysis, medical diagnosis, facial recognition, object recognition, fingerprint recognition, criminal investigation, and the like.

Further, detecting and localizing a salient object in an input image may be utilized to perform web image cropping, adaptive image display on mobile devices, ranking/re-ranking of search results and/or image filtering, i.e., detecting images that do not contain a salient object and discarding those images. Further still, color extraction within a region circumscribed by a salient image bounding box may be combined with other applications.

In order to process an input image, this disclosure describes processes for detecting whether the input image includes a salient object, such as vehicle “A” in the example above, and localizing the detected salient object within the input image. In some embodiments, a process may attempt to localize a salient object within the input image only after a salient object has been detected within the input image. In other words, if a salient object is not detected in the input image, then the process does not attempt to localize a salient object.

The processing of an input image may be two staged: (a) salient object detection; and (b) salient object localization. Salient object detection may be based at least in part on a detection model or classifiers generated from machine learning. The detection model or classifiers learn that salient objects in input images tend to have several characteristics such as, but not limited to, being different in appearance from its neighboring regions in the input image and being located near a center of the input image. The detection model or classifiers may be trained, via supervised training techniques, with labeled training data.

Salient object localization may be based at least in part on a localizer model generated from machine learning. The localizer model may be trained, via supervised training techniques, with labeled training data to enclose, envelope, circumscribe a detected salient object. The localizer model may be trained to provide a single salient object bounding box for an input image without a sliding window evaluation of the probability that the window contains a salient object. Further, the localizer model may be trained to provide single salient object bounding box for an input image without segmentation of the input image. The localizer model may be trained to choose the location and size of the salient object bounding boxes from labeled training data.

While aspects of described techniques can be implemented in any number of different computing systems, environments, and/or configurations, implementations are described in the context of the following example computing environment.

### Illustrative Environment

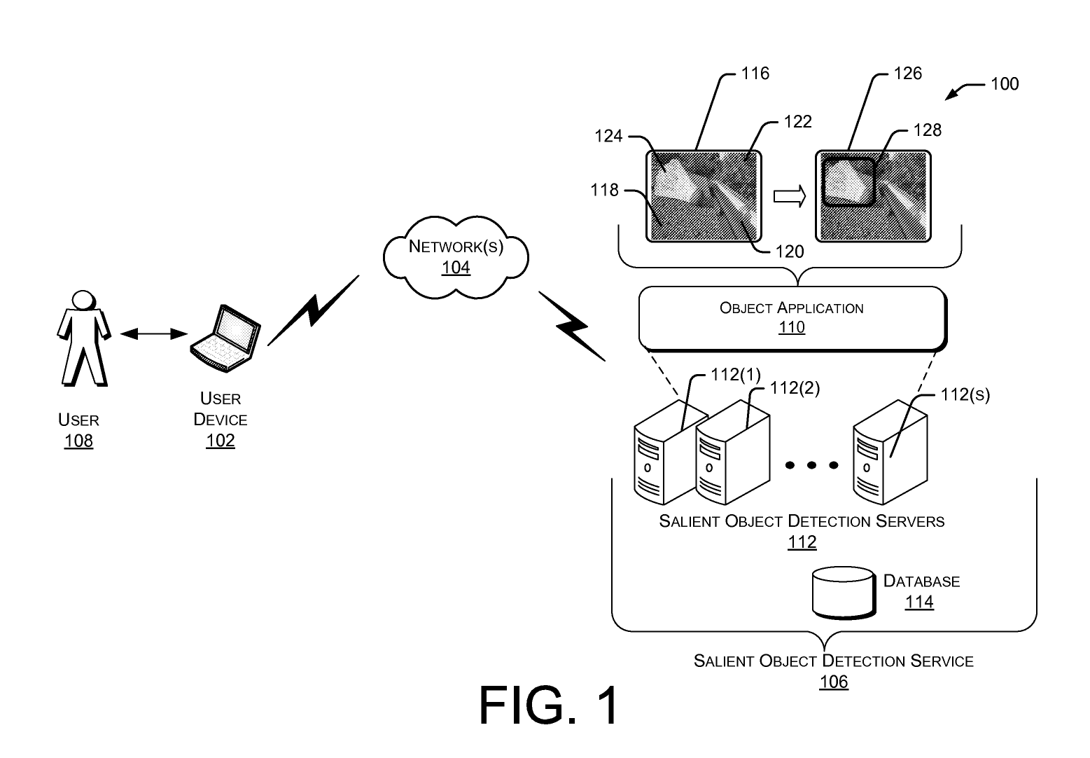

FIG. 1 illustrates an example architectural environment 100, in which detecting and localizing a salient object in an input image may be performed. The environment 100 includes an example user device 102, which is illustrated as a laptop computer. The user device 102 is configured to connect via one or more network(s) 104 to access a salient object detection service 106 for a user 108. It is noted that the user device 102 may take a variety of forms, including, but not limited to, a portable handheld computing device (e.g., a personal digital assistant, a smart phone, a cellular phone), a tablet, a personal navigation device, a desktop computer, a portable media player, or any other device capable of connecting to one or more network(s) 104 to access the salient object detection service 106 for the user 108.

The user device 102 may have additional features and/or functionality. For example, the user device 102 may also include additional data storage devices (removable and/or non-removable) such as, for example, magnetic disks, optical disks, or tape. Such additional storage may include removable storage and/or non-removable storage. Computer-readable media may include, at least, two types of computer-readable media, namely computer storage media and communication media. Computer storage media may include volatile and non-volatile, removable, and non-removable media implemented in any method or technology for storage of information, such as computer readable instructions, data structures, program modules, or other data. A system memory, the removable storage and the non-removable storage are all examples of computer storage media. Computer storage media includes, but is not limited to, RAM, ROM, EEPROM, flash memory or other memory technology, CD-ROM, digital versatile disks (DVD), or other optical storage, magnetic cassettes, magnetic tape, magnetic disk storage or other magnetic storage devices, or any other non-transmission medium that can be used to store the desired information and which can be accessed by the user device 102. Any such computer storage media may be part of the user device 102. Moreover, the computer-readable media may include computer-executable instructions that, when executed by the processor(s), perform various functions and/or operations described herein.

In contrast, communication media may embody computer-readable instructions, data structures, program modules, or other data in a modulated data signal, such as a carrier wave, or other transmission mechanism. As defined herein, computer storage media does not include communication media.

The network(s) 104 represents any type of communications network(s), including wire-based networks (e.g., cable), wireless networks (e.g., cellular, satellite), cellular telecommunications network(s), WiFi networks, and IP-based telecommunications network(s). The salient object detection service 106 represents a service that may be operated as part of any number of online service providers, such as a search engine, or for applications such as object recognition, medical image, and the like.

The salient object detection service 106 may operate in conjunction with an object application 110 that executes on one or more of the salient object detection and localization servers 112(1)-(S) and a database 114. The database 114 may be a separate server or may be a representative set of server 112 that is accessible via the network(s) 104. The database 114 may store information, such as algorithms or equations to perform the processes for detecting and localizing salient objects, images, models, and the like.

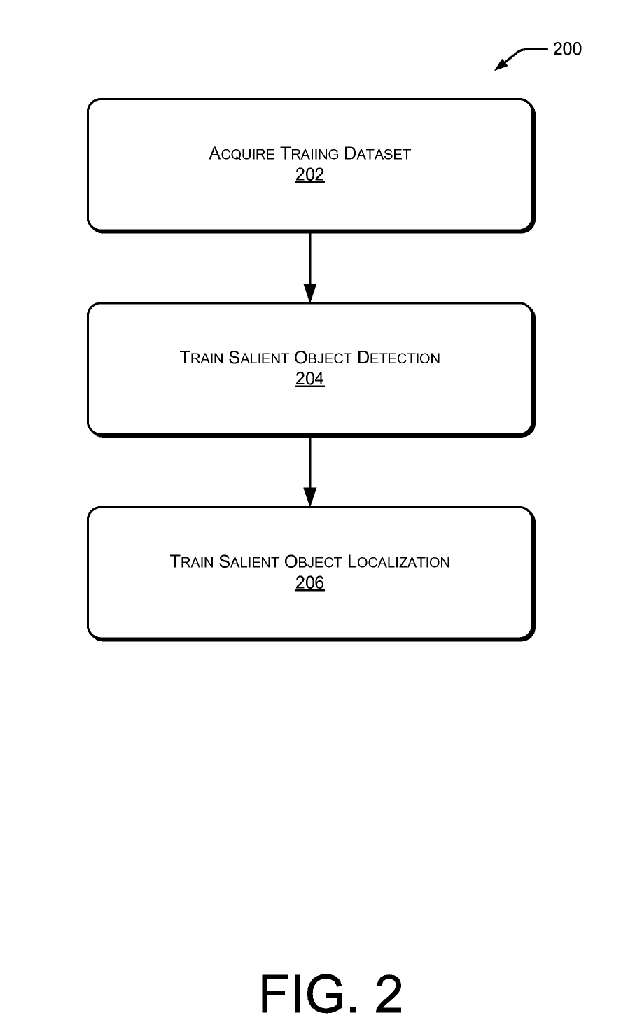

The object application 110 performs the processes described, such as creating saliency maps, creating feature vectors describing one or more images, machine learning of salient object detection and localization, receiving an input image, detecting a salient object in the input image, and generating a salient image bounding box. For instance, the object application 110 receives an input image 116 illustrating a portion of a roof 118 and gutter 120 with trees 122 in the background and a shuttlecock 124 on the roof 118. The object application 110 performs various techniques on the input image 116 to be discussed in details with references to FIGS. 2-5 and detects the shuttlecock 124 as the salient object in the input image 116 and localizes the shuttlecock 124. Based on the various techniques to be performed, an output image 126 is generated with a salient image bounding box 128 bounding the shuttlecock 124.

In some embodiments, the output image 126 may correspond to the input image 116 being cropped to the salient image bounding box 128.

In some embodiments, the portion of the input image 116 contained within the salient object bounding box 128 may be scaled to form the entirety of the output image 126.

In the illustrated example, the salient object detection and localization service 106 is hosted on one or more servers, such as salient object detection and localization server(s) 112(1), 112(2), . . . , 112(S), accessible via the network(s) 104. The salient object detection and localization servers 112(1)-(S) may be configured as plural independent servers, or as a collection of servers that are configured to perform larger scale functions accessible by the network(s) 104. The salient object detection and localization server(s) 112 may be administered or hosted by a network service provider that provides the salient object detection and localization service 106 to and from the user device 102.

### Processes

FIGS. 2-4 illustrate flowcharts showing example processes. The processes are illustrated as a collection of blocks in logical flowcharts, which represent a sequence of operations that can be implemented in hardware, software, or a combination. For discussion purposes, the processes are described with reference to the environment 100 shown in FIG. 1. However, the processes may be performed using different environments and devices. Moreover, the environments and devices described herein may be used to perform different processes.

For ease of understanding, the methods are delineated as separate steps represented as independent blocks in the figures. However, these separately delineated steps should not be construed as necessarily order dependent in their performance. The order in which the process is described is not intended to be construed as a limitation, and any number of the described process blocks maybe combined in any order to implement the method, or an alternate method. Moreover, it is also possible for one or more of the provided steps to be omitted.

### Training Salient Object Detection and Localization Processes

FIG. 2 is a flowchart of an example process 200 employed by the object application 110 for machine learning of salient object detection and localization. The object application 110 is trained to detect salient objects in images and to localize the detected salient objects for use in image searches, medical analysis or diagnosis, object or facial recognitions, criminal investigations, and the like.

At 202, a training image dataset is acquired. The training image dataset may include a large web image database collected from search queries of a search engine, and may also include manually labeled web images.

Images in the training image dataset may include salient-object images, i.e., images that contain a salient object, and non-salient-object images, i.e., images that do not contain a salient object. In some embodiments, the training image dataset may include metadata for manually labeled images. For example, the training image dataset may include metadata for hundreds of thousands of manually labeled web images or other manually labeled images. In some instances, metadata for labeled images may include salient object identifier information and/or salient object location information. Salient object identifier information may identify or classify a salient object. For example, metadata for the input image 116 may include “shuttlecock” for salient object identifier information. Salient object location information may provide location information for an identified salient object. For example, an input image could have a bounding box, which may be applied to the input image and/or be carried by metadata associated with the input image, for salient object location information.

In some instances, images of the training image dataset may be labeled in accordance with two rules. First, a bounding box for an image having a salient object should enclose, circumscribe, envelope the entire salient object and should be close to the boundaries of the salient object. Second, the bounding box should include objects that overlap or are very to the salient object.

A distribution of salient object bounding boxes may be learned based at least in part on the acquired training image dataset. In some instances, such as when the acquired training image dataset is from web searches, there may be a strong bias for large sizes of salient object bounding boxes and a strong bias toward the salient object bounding boxes to be located generally not far from the center of an image.

At 204, the object application 110 may be trained with the training image dataset to detect salient objects in images.

At 206, the object application 110 may be trained with the training image dataset to localize salient objects in images.

In some embodiments, the object application 110 may be trained to detect salient objects in images and/or to localize salient objects in images by employing: supervised learning techniques such as Bayesian statistics, decision tree learning, Naïve Bayes Classifier, Random Forrest, etc.; unsupervised learning techniques; semi-supervised learning techniques; and/or one or more combinations thereof.

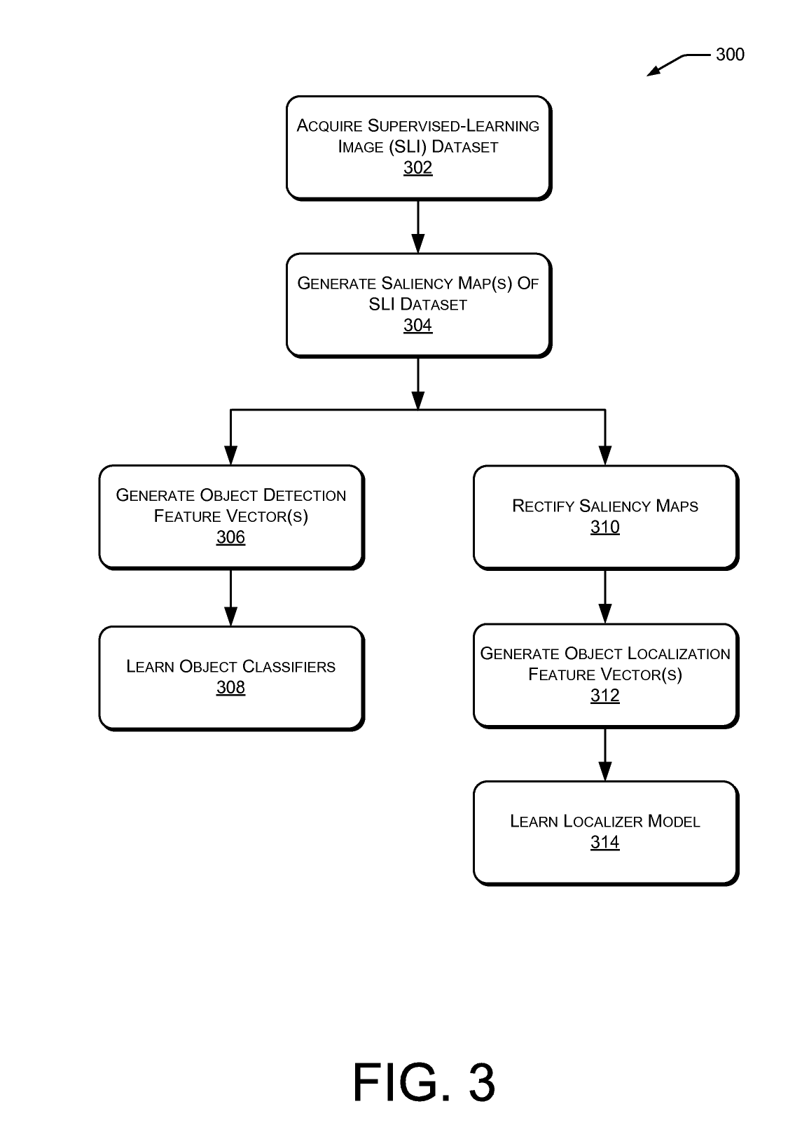

FIG. 3 is a flowchart of another example process 300 employed by the object application 110 for machine learning of salient object detection and localization. The process 300 separates the problem of learning of salient object detection and localization into a classification problem and a localization problem. In some instances, the acts pertaining to the “classification problem” may be done separately from the acts pertaining to the “localization problem.”

The process 300 utilizes a dataset having training features, {f₁, . . . , fₙ}⊂X and their associated label output {y₁, . . . , yₙ}⊂Y to learn a mapping g: X→Y, where the map g may be utilized to automatically detect and locate salient objects in new images. For such a dataset, the output space may be given by Y≡(o, t, l, b, r)|oε{+1, −1}, (t, l, b, r)ε [symbol] ⁴ s.t. t<b, l<r}, where “o” is indicative of whether or not a salient object is present in an image, “t,” “l,” “b,” “r” denote top, left, bottom, and right for representing the top-left and bottom-right corners of a salient object bounding box; and a binary classification space may be defined as O≡{+1, −1}, and the salient object bounding box space may be defined as W≡{(t, l, b, r)}. Then, the mapping function g may be given as g=(g_{c}, gₗ), where g_{c} indicates the mapping X→Y, and gₗ indicates the mapping X→W.

At 302, a supervised-learning image (SLI) dataset is acquired. The SLI dataset may include a large web image database collected from search queries of a search engine, where at least some of the images are manually labeled web images and/or have associated metadata for salient object identifier information and/or salient object location information. In some embodiments, the supervised-learning image (SLI) dataset may be utilized for both the “classification problem” and the “localization problem.” In other embodiments, separate SLI datasets (i.e., “classification” SLI dataset and “localization SLI dataset) may be acquired for the “classification problem” and the “localization problem.”

The SLI dataset includes a set of training features, {f₁, . . . , fₙ}⊂X and their associated label output {y₁, . . . , yₙ}⊂Y, and may be utilized to learn the mapping g: X→E The map g may be utilized to automatically detect and locate salient objects in new images.

In some instances, a person may manually label an image by drawing a closed shape, e.g., a square, rectangle, circle, ellipse, etc., to specify the location of a salient object region within the image. The closed shape is intended to be the most informative bounding box on that image. Furthermore, both salient-object images and non-salient-object images are labeled. Non-salient-object images may be labeled as, for example, “no object.”

In instances in which a salient object bounding box is approximately a square or rectangle, a given image (Iᵢ) in the SLI dataset may have a corresponding label yᵢ=(o; t, l, b, r), where “o” is indicative of whether or not a salient object is present in an image, and “t,” “l,” “b,” “r” denote top, left, bottom, and right for representing the top-left and bottom-right corners of a salient object bounding box. The label yᵢ may be included in metadata associated with the image Iᵢ.

In some instances, images are collected from searching queries and the images may have relative low quality. For example, the images may have a resolution that is approximately in the range 120-130 pixels by 120-130 pixels. The object application 110 may use such relatively low quality images in training for salient object detection and localization.

Frequently, a salient object is generally located proximal to a center, or image center, of an image. However, for images in which a salient object is small relative to the size of the image (i.e., the salient object occupies a relatively small fraction, e.g., approximately in the range 1/25- 1/16, of the image) and/or images in which the salient object is far away from image center (e.g., the center of the salient object is offset from the image center by an amount of approximately 0.25 N_{X} or N_{y} or more, where N_{X} and N_{y} are the number of pixels in x and y directions, respectively, of the image), it can be difficult to determine the correct size of salient object bounding box.

At 304, saliency maps are generated from the SLI dataset. For non-salient-object images, the generated saliency map is generally clutter and is less likely to form a closed region. On the other hand, salient-object images generally produce a saliency map with compact and closed salient region. Moreover, for localization, the saliency map generally points out the salient object. In embodiments in which separate “classification” and “localization” SLI datasets are acquired, separate sets of saliency maps (i.e., “classification” saliency maps and “localization” saliency maps) may be generated from the corresponding “classification” SLI dataset and “localization” SLI dataset.

In some instances, the object application 110 may generate a saliency map for a given image by calculating a calculating a saliency value for each pixel on the given image and arrange the saliency values to correspond to the pixels in the given image. Such a saliency map may be based at least in part on color and orientation information using “center-surround” operations akin to visual receptive fields. In some instances, the object application 110 may generate a saliency map for a given image based at least in part on regions of the given image. For example, the object application 110 may define the saliency of a region of an image with respect to its local context, i.e., neighboring regions, instead of with respect to its global context, i.e., all of the regions of the image. In some instances, the saliency of regions may be propagated to pixels. Further details of saliency maps may be found in U.S. patent application Ser. No. 13/403,747, entitled “SALIENT OBJECT SEGMENTATION.”

In some instances, the object application 110 may fragment the input image into multiple regions. Each of the multiple regions in the input image is distinguished from a neighboring region based at least in part on that a higher saliency value computed for a region as the region is better distinguished from its immediate context. The immediate context being defined as immediate neighboring regions of the region. A high saliency value is often computed for the region near the center of the image. Spatial neighbors are two regions that share a common boundary. The propagating of the saliency value from the regions to the pixels creates a full-resolution saliency map.

In some instances, multiple base saliency maps may be generated from a single given image, and the multiple base saliency maps may be used to form a total saliency map. For example, the object application 110 may generate base saliency maps utilizing pixel contrast and region contrast from a single given image, and the multiple base saliency maps may then be utilized to generate a total saliency map.

In some embodiments, each base saliency map may be normalized in the range of [0, 1], and in some embodiments, total saliency maps may be normalized in the range of [0, 1].

In some instances, the pixel level contrast information may be from one or more of (a) multi-contrast (MC), (b) center surround-histogram (CSH) and (c) color spatial distribution (CSD), and the region level contrast information may be from a saliency map given by spatial weighted region based contrast (RC). The base saliency maps may be partitioned into N=p×q grid and the mean value inside each grid may then be extracted. Further details regarding saliency information and maps may be found in “Salient Object Detection for Searched Web Images via Global Saliency,” Peng Wang, Jingdong Wang, Gang Zeng, Jie Feng, Hongbin Zha, Shipeng Li, CVPR 2012 ([http:www].cypapers.com/cypr2012.html), which is incorporated by reference herein in its entirety.

At 306, feature vectors such as object detection feature vectors are generated based at least in part on one or more saliency maps. Typically, the feature vectors are generated from total saliency maps. However, in some embodiments, base saliency maps may be utilized.

In some embodiments, base saliency maps from a given image may be combined by separately stacking (or concatenating) a set of base saliency maps into one feature vector of length K×p×q, where K is the number of base saliency maps, and p and q are the partition sizes. For example, a feature vector in which four base saliency maps are utilized could be defined as:

f=[f_{mc}^{T},f_{csh}^{T},f_{csd}^{T},f_{rc}^{T}]^{T}. (1)

In some embodiments, base saliency maps from a given image may be combined by summing all of the base saliency maps into one single total saliency map. In some embodiments, the base saliency maps may be combined linearly, and in some embodiments, the base saliency maps may be combined non-linearly. For example, a non-linear combination may be defined as:

fᵢ=(Σₖ₌₁^{K}λₖf_{k,j})²,j=1, . . . N, (2)

where is a weight assigned to the k^{th} base saliency map, k is the index to the set of base saliency maps utilized in the combination, and j is the index to the feature dimension. The weighting coefficients (λ={λₖ}) of the base saliency maps may, in some embodiments, be learned utilizing a segmentation dataset with accurate object boundary. For example, the weighting coefficients λ={0.14; 0.21; 0.21; 0.44} were utilized in experiments discussed in “Salient Object Detection for Searched Web Images via Global Saliency,” Peng Wang et al, supra.

At 308, object classifiers are learned. The learned object classifiers may learn to map an input image to either a set of images having a salient object or to a set of images that does not have a salient object. In some embodiments, a Random Forrest classifier may be utilized to learn classifiers that detect salient objects in the SLI dataset.

At 310, a rectification of the saliency maps may be performed in order to deal with the translation and scale of the saliency object bounding box from the image center. A single two dimensional Gaussian may be estimated from a total salient map. Mathematically, the un-normalized Gaussian function takes the form that G(x)=Aexp(−(x−μ)^{T} sigma⁻¹(x−μ)), where

$$sigma = [ \begin{matrix}{σ}_{x}^{2} & 0 \\ 0 & {σ}_{y}^{2}\end{matrix} ] .$$

The parameters of the Gaussian function may be estimated by Least Square Estimation. The image center may be translated to the position μ=(μₓ, μ_{y})^{T} and the image may be cropped on the coordinate x and coordinate y based on the estimated μₓ, μ_{y} and σₓ, σ_{y}, respectively, e.g., the range of coordinate x on image may be defined to be [μₓλₓσₓ, μₓ+λₓσₓ] and the range of coordinate y on image may be defined to be [μ_{y}λ_{y}σ_{y}, μ_{y}+−λ_{y}σ_{y}]. In some instances, λₓ and λ_{y} may be set to a value of approximately 3. Through the rectification the salient object in the image may be approximately at the center position of the cropped image and approximately regular size.

In embodiments in which separate “classification” and “localization” SLI datasets are acquired, the saliency maps generated from the localization” SLI dataset may be rectified.

At 312, feature vectors such as object localization feature vectors are generated based at least in part on one or more saliency maps. Typically, the feature vectors are generated from total saliency maps. However, in some embodiments, base saliency maps may be utilized. In some instances, as discussed above, total saliency maps may be a combination of multiple base saliency maps stacked or concatenated together. In other instances, as discussed above, total saliency maps may be a non-linear combination of multiple base saliency maps.

At 314, a localizer model is learned. The localizer model finds a location for a saliency object bounding box that circumscribes a salient object in an image. In some embodiments, the localizer model may be learned utilizing a regression machine learning algorithm. The posterior distribution P(w:F) linking the input and output space may be utilized to model the mapping gᵢ in which the input and output space and training set are denoted by {f⁽ⁿ⁾,w⁽ⁿ⁾}ₙ₌₁^{N}, where wεW. For a high-dimensional feature space, such a problem needs to build a partition P over the input space, and the model within each cell could be simple. In some instances, a single partition P may be replaced by an ensemble of independent random partitions {P_{z}}_{z=1}^{Z} that may lead to an ensemble regressor that may achieve better generalization.

In some embodiments, Random Forests may be utilized to construct multiple partitions {P_{z}}_{z=1}^{Z}, which have been widely used to localize the organs in medical images and estimate the poses on depth image for its efficiency. The posterior estimated from the different partitions in Random Forests may be combined through averaging. The localizer may estimate in one shot the position of regions of interest contained in variable using the mathematical expectation: w̅=∫_{w}wp(w)dw.

### Salient Object Detection and Localization in an Input Image

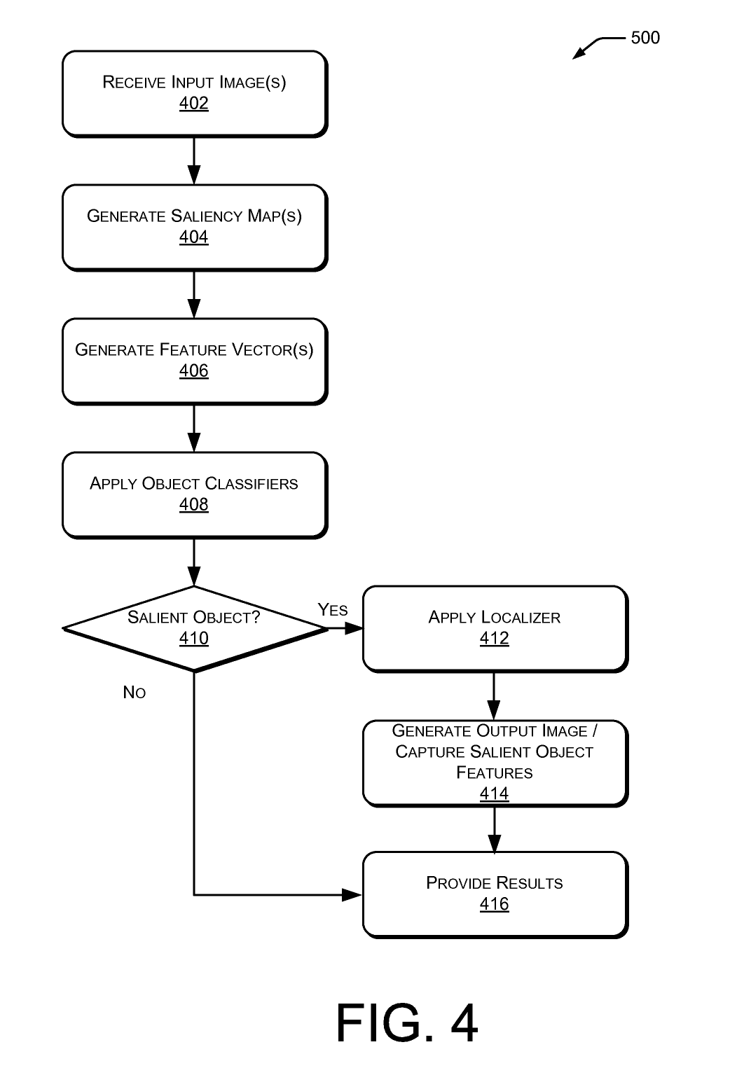

FIG. 4 is a flowchart illustrating an example process 400 for detecting a salient object and localizing same in an input image.

At 402, the object application 110 receives the input image 116 from a collection of photographs, from various applications such as a photograph sharing website, a social network, a search engine, and the like. The input image 116 may include but is not limited to, digital images of people, places or things, medical images, fingerprint images, video content, and the like. The input image may take many forms, such as video sequences, views from multiple cameras, or multi-dimensional data from a medical scanner.

At 404, the object application 110 generates one or more saliency maps from the input image 116. In some instances, the object application 110 may generate pixel based saliency maps such as, but not limited to, multi-contrast (MC) saliency maps, center surround-histogram (CSH) saliency maps and color spatial distribution (CSD) saliency maps. In some instances, the object application 110 may generate region based saliency maps such as, but not limited to, region contrast (RC) saliency maps.

In some embodiments, the object application 110 may generate one or more base saliency maps (e.g., MC saliency maps, CSH saliency maps, CSD saliency maps and RC saliency maps) and may generate from the base saliency maps a total saliency map.

At 406, the object application 110 may generate feature vectors based at least in part on the generated saliency maps. In some embodiments, the object application 110 may generate feature vectors based at least in part on base saliency maps, and in other embodiments, the object application 110 may generate feature vectors based at least in part on total saliency maps.

At 408, the object application 110 may apply learned object classifiers to the feature vectors of the input image 160 for detecting a salient object.

At 410, the object application 110 may determine whether the input image 160 includes a salient object. If affirmative, the process continues to 412, and if negative, the process continues at 416.

At 412, the object application 110 may apply the localizer to localize the detected salient object in the input image 160. The object application 110 may determine one or more location indicators and/or size indicators that may be utilized for drawing a closed shape circumscribing the detected salient object. For example, in some embodiments, the object application 110 may circumscribe the detected salient object with a salient object bounding box, and the salient object bounding box may be defined by a pair of opposite points (or location indicators), e.g., the top-left corner and the bottom-right corner. In such a situation, the object application 110 may not provide a size indictor for the salient object bounding box circumscribing the detected salient object. However, in some embodiments, the object application 110 may circumscribe the detected salient object with a circle and may provide a location indicator for the center of the circle and a size indicator for the radius of the circle.

At 414, the object application 110 may, in some instances, generate the output image 126, which may include the salient object bounding box 128. The object application 110 may draw the salient object bounding box 128 to envelope or circumscribe the detected salient object based at least in part on the one or more location indicators and/or size indicators.

In some embodiments, the object application 110 may capture features of the detected salient object. In some instances, the object application 110 may generate one or more feature vectors for features of the detected salient object based at least in part on the salient object bounding box 128. In other instances, the object application may identify which elements of the feature vector for the input image 116 correspond to features of the detected salient object and capture the identified elements.

At 416, the object application 110 may provide results for salient object detection and localization of the input image 116. In some instances, the results may be provided to a sender of the input image 116 such as a search engine or a user. In some instances, the results may include the output image 126 with the salient object bounding box 128. In some instances, the results may information pertaining to the detected salient object such as, but not limited to, features of the detected salient object. In some instances, the results may include one or more feature vectors corresponding to features of the detected salient object. In some instances, the results may include an indication that the input image 116 did not contain a salient object.

### Example Server Implementation

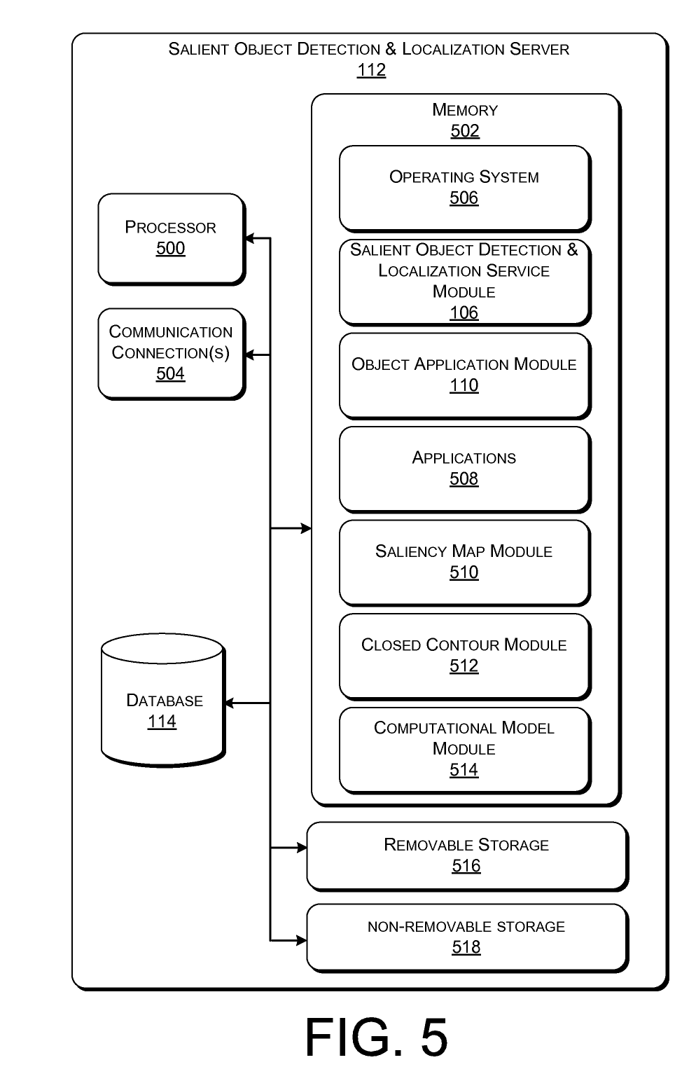

FIG. 5 is a block diagram to illustrate an example server usable with the environment of FIG. 1. The salient object detection and localization server 112 may be configured as any suitable system capable of services, which includes, but is not limited to, implementing the salient object detection and localization service 106 for image searches, such as providing the search engine to perform the image search. In one example configuration, the server 112 comprises at least one processor 500, a memory 502, and a communication connection(s) 504. The processor(s) 500 may be implemented as appropriate in hardware, software, firmware, or combinations thereof. Software or firmware implementations of the processor(s) 500 may include computer-executable or machine-executable instructions written in any suitable programming language to perform the various functions described.

Similar to that of architectural environment 100 of FIG. 1, memory 502 may store program instructions that are loadable and executable on the processor(s) 500, as well as data generated during the execution of these programs. Depending on the configuration and type of computing device, memory 502 may be volatile (such as random access memory (RAM)) and/or non-volatile (such as read-only memory (ROM), flash memory, etc.).

The communication connection(s) 504 may include access to a wide area network (WAN) module, a local area network module (e.g., WiFi), a personal area network module (e.g., Bluetooth), and/or any other suitable communication modules to allow the salient object detection and localization server 112 to communicate over the network(s) 104.

Turning to the contents of the memory 502 in more detail, the memory 502 may store an operating system 506, the salient object detection and localization service module 106, the object application module 110, and one or more applications 508 for implementing all or a part of applications and/or services using the salient object detection and localization service 106.

The one or more other applications 508 may include an email application, online services, a calendar application, a navigation module, a game, and the like. The memory 502 in this implementation may also include a saliency map module 510, a closed contour module 512, and a computational model module 514.

The object application module 110 may perform the operations described with reference to the figures or in combination with the salient object detection and localization service module 106, the saliency map module 510, the closed contour module 512, and/or the computational model module 514.

The saliency map module 510 may perform the operations separately or in conjunction with the object application module 110, as described with reference to FIGS. 3-4. The closed contour module 512 may perform the operations separately or in conjunction with the object application module 110, as described with reference to FIGS. 3-4. The computational model module 514 may create models using the equations described above in calculating the saliency values for each region; calculating the saliency for pixel, constructing saliency maps; constructing the optimal closed contour; and generating feature vectors of images and feature vectors of detected salient objects. The computational model module 514 may include a salient object detection model module for detecting whether an input image includes a salient object and may also include a localizer model module for localizing a detected salient object.

The server 112 may include the database 114 to store the computational models, the saliency maps, the extracted shape priors, a collection of segmented images, algorithms, and the like. Alternatively, this information may be stored on other databases.

The server 112 may also include additional removable storage 516 and/or non-removable storage 518 including, but not limited to, magnetic storage, optical disks, and/or tape storage. The disk drives and their associated computer-readable media may provide non-volatile storage of computer readable instructions, data structures, program modules, and other data for the computing devices. In some implementations, the memory 502 may include multiple different types of memory, such as static random access memory (SRAM), dynamic random access memory (DRAM), or ROM.

The server 112 as described above may be implemented in various types of systems or networks. For example, the server may be a part of, including but is not limited to, a client-server system, a peer-to-peer computer network, a distributed network, an enterprise architecture, a local area network, a wide area network, a virtual private network, a storage area network, and the like.

Various instructions, methods, techniques, applications, and modules described herein may be implemented as computer-executable instructions that are executable by one or more computers, servers, or computing devices. Generally, program modules include routines, programs, objects, components, data structures, etc. for performing particular tasks or implementing particular abstract data types. These program modules and the like may be executed as native code or may be downloaded and executed, such as in a virtual machine or other just-in-time compilation execution environment. The functionality of the program modules may be combined or distributed as desired in various implementations. An implementation of these modules and techniques may be stored on or transmitted across some form of computer-readable media.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

What is claimed is:

1. A method implemented at least partially by a processor, the method comprising:
receiving an input image;
generating a saliency map of the input image;
generating at least one feature vector based at least in part on the saliency map;
detecting whether the input image has or does not have a salient object based at least on a learned salient object detection model; and
responsive to detecting that the input image has a salient object, localizing the detected salient object in the input image based at least in part on a learned localization model.

2. The method of claim 1, wherein the saliency map is a total saliency map, and wherein the generating a saliency map of the input image comprises:
generating a plurality of base saliency maps of the input image, each base saliency map being different from other base saliency maps; and
combining the plurality of base saliency maps into the total saliency map.

3. The method of claim 2, wherein the combining the plurality of base saliency maps into the total saliency map comprises:
concatenating the plurality of base saliency maps into the total saliency map.

4. The method of claim 2, wherein the combining the plurality of base saliency maps into the total saliency map comprises:
non-linearly combining the plurality of base saliency maps into the total saliency map.

5. The method of claim 1, wherein the learned salient object detection model is trained via supervised learning with a dataset having labeled images.

6. The method of claim 5, wherein the dataset includes salient-object images and non-salient object images.

7. The method of claim 1, wherein the learned salient object detection model is learned from a classification model.

8. The method of claim 1, wherein the localizing the detected salient object in the input image based at least in part on a learned localization model comprises:
generating a salient object bounding box that circumscribes the detected salient object.

9. The method of claim 8, further comprising:
cropping the input image to approximate the salient object bounding box; and
providing as an output image the cropped input image.

10. One or more computer-readable storage media encoded with instructions that, when executed by one or more processors, cause the one or more processors to perform acts comprising:
receiving an input image;
generating a saliency map of the input image;
generating at least one feature vector based at least in part on the saliency map;
detecting whether the input image has or does not have a salient object based at least on a learned salient object detection model;
responsive to detecting that the input image has a salient object, localizing the detected salient object in the input image based at least in part on a learned localization model; and
providing an output that includes information pertaining to the detected salient object.

11. The computer-readable storage media of claim 10, wherein the saliency map is a total saliency map, and wherein the generating a saliency map of the input image comprises:
generating a plurality of base saliency maps of the input image, each base saliency map being different from other base saliency maps; and
combining the plurality of base saliency maps into the total saliency map.

12. The computer-readable storage media of claim 11, wherein the combining the plurality of base saliency maps into the total saliency map comprises:
non-linearly combining the plurality of base saliency maps into the total saliency map.

13. The computer-readable storage media of claim 10, wherein the information pertaining to the detected salient object included in the output is indicative of the input object not having a salient object.

14. The computer-readable storage media of claim 10, wherein the information pertaining to the detected salient object included in the output is indicative of a salient object bounding box that circumscribes the detected salient object.

15. The computer-readable storage media of claim 10, wherein the localizing the detected salient object in the input image based at least in part on a learned localization model comprises:
generating a salient object bounding box that circumscribes the detected salient object.

16. The computer-readable storage media of claim 10, wherein the learned salient object detection model is trained via supervised learning with a dataset having labeled images acquired from web searches.

17. The computer-readable storage media of claim 10, wherein the learned salient object detection model is trained via supervised learning with a dataset having labeled thumbnail images.

18. A system comprising:
a memory;
one or more processors coupled to the memory;
an object application module executed on the one or more processors to receive an input image;
a saliency map module executed on the one or more processors to construct a plurality of base saliency maps from the input image and to combine the plurality of base saliency maps into a total saliency map;
a saliency object detection module executed on the one or more processors to detect whether the input image has or does not have a salient object, the saliency object detection module trained via supervised training with a labeled dataset comprised of images acquired via web searches; and
a localizer module executed on the one or more processors to localize a salient object in the input image responsive to the saliency object detection module detecting a salient object in the input image.

19. The system of claim 18, wherein the localizer module is further executed on the one or more processors to:
construct a saliency object bounding box that circumscribes the detected salient object.

20. The system of claim 19, wherein the localizer module is further executed on the one or more processors to:
crop the input image to approximate the salient object bounding box; and
provide as an output image the cropped input image.
